(19) United States
(12) Patent Application Publication
(10) Pub. No.: US 2007/0253421 A1
(43) Pub. Date: Nov. 1, 2007

(54) SELECTIVE RECEPTION OF MULTI USER JOINT CODED PACKETS

(75) Inventor: Zhijun Cai, Euless, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/381,096

(22) Filed: May 1, 2006

(51) Int. Cl. H04L 12/56; H04J 3/04

(52) U.S. Cl. 370/394; 370/535

(57) ABSTRACT

Methods and corresponding systems for communicating data include concatenating sub-packets designated, respectively, for a first user device and a second user device to form a multiplexed data frame. A control channel message is produced to indicate that the first and second user devices have sub-packets in the multiplexed data frame. The control channel message is sent for transmission on a shared control channel, and the multiplexed data frame is sent for transmission on a data channel. The multiplexed data frame can be encoded. The shared control channel message can include a group ID and intra-group data for notifying user devices with an assigned group ID and intra-group ID. The intra-group data can include a bit mapped field having bits corresponding to the intra-group IDs.

### FIELD OF THE INVENTION

This invention relates in general to data communication, and more specifically to techniques and apparatus for selectively receiving packets having jointly coded data for multiple users.

### BACKGROUND OF THE INVENTION

High speed downlink packet access (HSDPA) is a new mobile telephony protocol, which is sometimes referred to as 3.5 G technology. HSPDA provides a smooth evolutionary path for Universal Mobile Telecommunications System (UMTS) networks allowing for higher data capacity.

The HSDPA specification defines a new W-CDMA channel—the high-speed downlink shared channel (HS-DSCH). The HS-DSCH channel uses Adaptive Modulation and Coding (AMC), fast scheduling at the Node B (Base Station), and fast retransmissions to deliver the improved downlink performance. The 2 ms frames of a specific HS-DSCH downlink channel is shared between user devices, wherein data designated for different user devices is contained in alternating, or different, frames. (Multiple HS-DSCH channels can be separated by channelization codes in the system.) This can leave some frames partially filled, and delay data sent to a first user device while data is being sent to a second user device.

### BRIEF DESCRIPTION OF THE DRAWINGS

The accompanying figures, wherein like reference numerals refer to identical or functionally similar elements throughout the separate views and which together with the detailed description below are incorporated in and form part of the specification, serve to further illustrate various embodiments and to explain various principles and advantages, all in accordance with the present invention.

FIG. 1 depicts, in a simplified and representative form, a high-level block diagram of a communication system having a base station and a plurality of user devices in accordance with one or more embodiments;

FIG. 2 is a detailed representative diagram of a data channel transmission format in accordance with one or more embodiments;

FIG. 3 depicts a representative diagram of a shared control channel transmission format in accordance with one or more embodiments;

FIG. 4 shows a high-level flowchart of processes executed by a packet transmission system that can be used in conjunction with the FIG. 1 base station in accordance with one or more embodiments; and

FIG. 5 depicts a high-level flowchart of processes executed by a packet receiver system that can be used in conjunction with the FIG. 1 user device in accordance with one or more embodiments.

### DETAILED DESCRIPTION

In overview, the present disclosure concerns communications systems using high-speed downlink packet access. More particularly various inventive concepts and principles embodied in methods and apparatus may be used for improving throughput and encoding efficiency and reducing overhead in systems using high-speed downlink packet access techniques to transmit multiplexed data packets to multiple users.

While the base station, user device, or communication system of particular interest may vary widely, one embodiment may advantageously be used in a wireless communication system or a wireless networking system, such as a 3GPP (3rd Generation Partnership Project) cellular communications system using High-Speed Downlink Packet Access (HSDPA).

The instant disclosure is provided to further explain, in an enabling fashion, the best modes, at the time of the application, of making and using various embodiments in accordance with the present invention. The disclosure is further offered to enhance an understanding and appreciation for the inventive principles and advantages thereof, rather than to limit the invention in any manner. The invention is defined solely by the appended claims, including any amendments made during the pendency of this application, and all equivalents of those claims as issued.

It is further understood that the use of relational terms, if any, such as first and second, top and bottom, and the like, are used solely to distinguish one entity or action from another without necessarily requiring or implying any such actual relationship or order between such entities or actions.

Much of the inventive functionality and many of the inventive principles can be implemented with, or in, integrated circuits (ICs), including possibly application specific ICs, or ICs with integrated processing controlled by embedded software or firmware. It is expected that one of ordinary skill, when guided by the concepts and principles disclosed herein, will be readily capable of generating such software instructions and programs and ICs with minimal experimentation—notwithstanding possibly significant effort and many design choices motivated by, for example, available time, current technology, and economic considerations. Therefore, in the interest of brevity and minimization of any risk of obscuring the principles and concepts according to the present invention, further discussion of such software and ICs, if any, will be limited to the essentials with respect to the principles and concepts of the various embodiments.

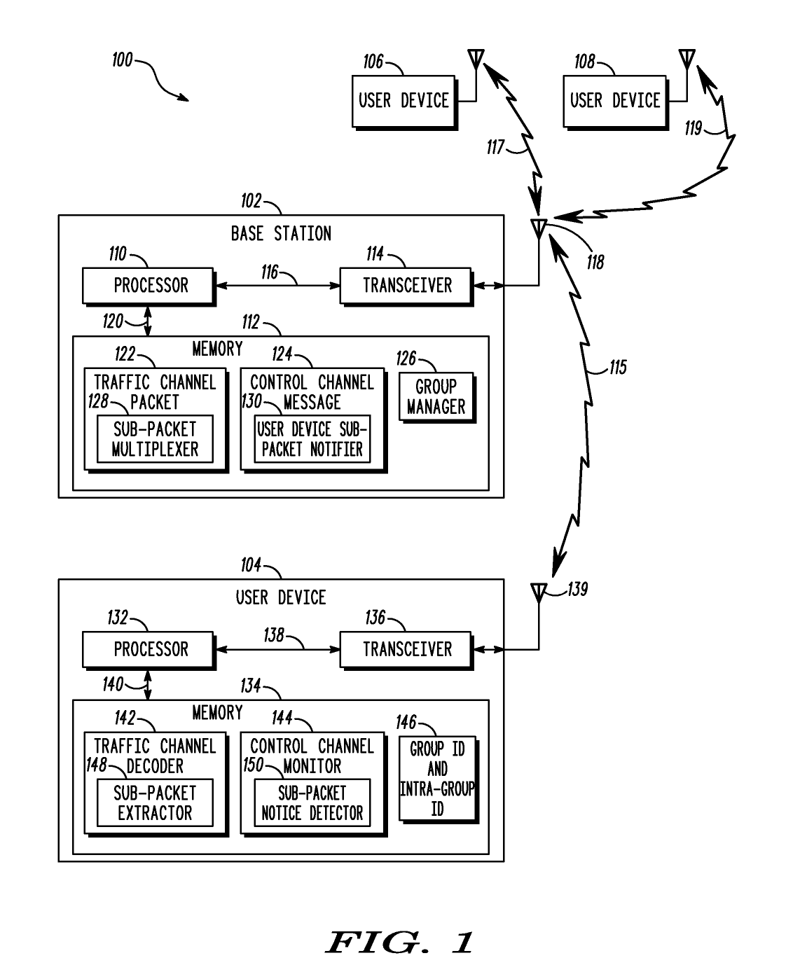

Referring to FIG. 1, there is depicted a high-level block diagram of a communication system having a base station in wireless data communication with a plurality of user devices in accordance with one or more embodiments. As illustrated, data communication system 100 includes base station 102 and a plurality of user devices 104-108. Base station 102 is capable of wirelessly transmitting or communicating high-speed data packets with user devices 104-108 using a method and system that is an improvement over HSDPA.

Base station 102 is one of typically a multiplicity of base stations. Base station 102 is one of typically many infrastructure devices. For example, base station 102 is typically coupled to a base site controller together with other base stations and the base site controllers are typically coupled to one or more network switches, billing processors, routers, or the like. Some of the functionality attributed to the base station may occur or take place, for example, in a base site controller, switch, or the like.

Base station 102 includes processor 110, which is coupled to memory 112 and transceiver 114. Processor 110 performs many of the functions and operations within base station 102 by executing program code and using data stored in memory 112. In one embodiment, processor 110 can include one or more microprocessors, microcontrollers, or digital signal processors. Memory 112 can include some combination of generally known memory technology, e.g., RAM, ROM, EEPROM, magnetic, optical memory, etc.

Processor 110 can be coupled to transceiver 114 through interface 116. In one embodiment, interface 116 can transfer data for transmission from transceiver 114, data received by transceiver 114, and various control and command signals. Transceiver 114 is generally known and can include baseband logic and radio frequency circuits for encoding, modulating, and transmitting, and conversely receiving, demodulating, and decoding, signals that are transmitted and received using antenna 118. Base station 102 can communicate wirelessly with user devices 104-108 by wireless communication channels 115, 117, and 119, respectively. In one embodiment, transceiver 114 can communicate with user devices 104-108 using the 3GPP wireless communication standard protocol, or other similar protocols.

Processor 110 can be coupled to memory 112 through interface 120, which, in one embodiment, is able to transfer data and program code for processing and execution in processor 110. In some embodiments, processor 110 can also include memory.

Memory 112 can include program code and data for executing various algorithms, processes, and methods within processor 110 and base station 102. For example, memory 112 can include program code for processes and algorithms that implement traffic channel packet generator 122, and that implement control channel message generator 124, and that manage groups 126 and corresponding group member identifications for groups of user devices.

Part of the program code for generating traffic channel packets (e.g., traffic channel packet generator 122) can include program code for multiplexing sub-packets (e.g., sub-packet multiplexer 128) designated for two or more user devices, such as user devices 104-108. As described in more detail below, this multiplexing operation includes processes and algorithms for concatenating sub-packets that are designated for transmission to different user devices (e.g., user device 104 and user device 106), and thus producing a “multiplexed” data packet or frame.

A portion of the program code for generating control channel messages (e.g., control channel message generator 124) can include program code for generating notification messages (e.g., user device sub-packet notifier 130) for user devices that have sub-packets in an upcoming multiplexed packet. As described in more detail below, this process or algorithm generates a message for transmission on a control channel that notifies two or more user devices that a scheduled or upcoming multiplexed data packet to be transmitted on a traffic channel contains a sub-packet designated for the user device.

While much of the functionality discussed above has been attributed to software instructions as executed by the processor, it will be appreciated that many of these operations can also be performed by hardware or some combination of software and hardware. Additionally, as will be appreciated by those of ordinary skill, a multiplicity of other functions or operations (not specifically shown) are performed in a typical base station, and various of those can be implemented, at least in part, with the processor(s) and various software instructions, etc.

With regard to the configuration of the user devices, some of the components within the user devices 104-108 are functionally similar to corresponding hardware, firmware, or software in base station 102. This is because user device 104 and base station 102 can perform complimentary operations, such as encoding and decoding, modulating and demodulating, transmitting and receiving, and the like. For example, user devices 104-108, can include processor 132 coupled to both memory 134 and transceiver 136. Notwithstanding the functional similarity, the processor, memory, and transceiver included with the user devices are typically quite unique from the corresponding elements of the base station, as will be appreciated by those of ordinary skill.

Processor 132 can be coupled to transceiver 136 through interface 138, which can transfer data for transmission by transceiver 136, data received by transceiver 114, and various other control and command signals. Transceiver 136 can include baseband logic and radio frequency circuits for encoding, modulating, and transmitting, and conversely receiving, demodulating, and decoding signals that are transmitted and received using antenna 139. In one embodiment, transceiver 136 communicates wirelessly with base station 102 using the 3GPP wireless communications standard protocol, or other similar protocols.

Memory 134, which is coupled to processor 132 via interface 140, can include software code and data for executing algorithms, processes, and methods within processor 132, and generally within user device 104. For example, memory 134 can include software code for processes and algorithms that implement traffic channel decoder 142, control channel monitor 144, and group identification (group ID) data manager 146, and other processes.

A portion of the software code that implements traffic channel decoder 142 can include software code for implementing sub-packet extractor 148, which, as described in greater detail below, is software code for extracting a sub-packet designated for user device 104 from among other sub-packets in a multiplexed packet designated for other user devices, such as user devices 106 and 108.

Part of the software for implementing control channel monitor 144 can include software code for implementing sub-packet notice detector 150, which, as described more fully below, is software code for processing a notice message that gives notice to user device 104 that an upcoming multiplexed packet transmitted from base station 102 includes a sub-packet designated for user device 104.

Software code for implementing group ID manager 146 can include program code for receiving and storing in memory 134 a group ID and an intra-group ID from base station 102, and, more specifically, Control channel message 304 can include the group ID and an intra-group ID as provided from group manager 126.

While the functionality of the user device has been discussed and described in the context of a processor executing software code or instructions, it will be evident to those of ordinary skill that these operations or processes can be performed by hardware, or a combination of software and hardware. It will also be appreciated that various other functions typically found in a user device e.g., a user interface and others, have not been discussed or described. Those of ordinary skill will realize that many of these functions can be implemented or facilitated by the processor executing software code or instructions stored in the memory.

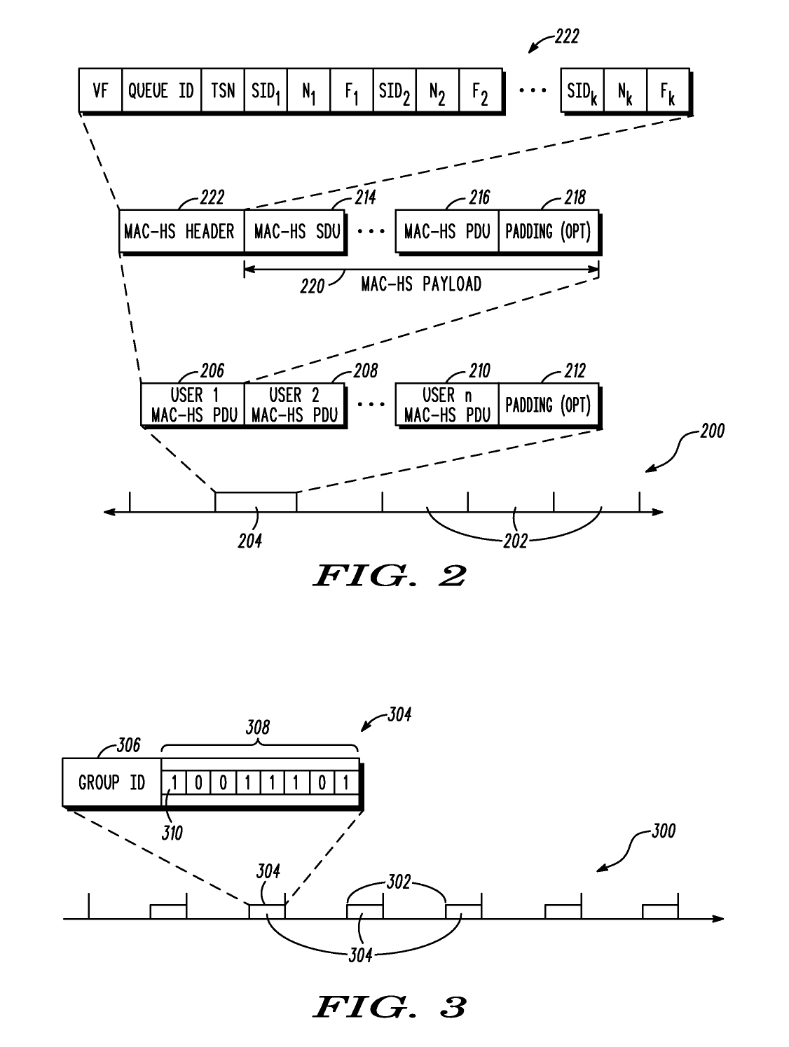

With reference now to FIG. 2, there is depicted a detailed representative diagram of a data channel transmission format in accordance with one or more embodiments. As shown, timeline 200 represents a plurality of transmission time intervals 202 for transmitting data frames or data packets on a high speed downlink packet access channel in accordance with one or more embodiments. In one embodiment, each transmission time interval 202 is 2 ms, but other transmission time intervals can be used in other embodiments.

Within each transmission time interval 202, base station transceiver 114 can transmit a multiplexed data frame 204, which is a data frame having sub-packets that have been designated for transmission to two or more user devices, such as two or more of user devices 104-108. Multiplexed data frame 204 may also be referred to as a “super MAC—hs PDU,” which stands for Medium Access Control-high speed Protocol Data Unit. Sub-packets 206, 208, and 210 are shown in multiplexed data packet 204. Sub-packets 206 through 210 (which may also be referred to as “protocol data units”) are designated for transmission to user 1, user 2, . . . , and user n, which is an example of sub-packets within a single multiplexed data frame 204 that are transmitted in a particular transmission time interval 202 on the high-speed physical downlink shared channel and designated for at least two different user devices.

In order to provide a multiplexed data frame 204 that is full of data, padding data 212 can be added or appended to multiplexed data frame 204. Padding data 212 can include zeros that are inserted to fill out multiplexed data frame 204.

Each sub-packet 206-210 can include one or more Service Data Units (SDUs) for a designated user device, and optional padding to complete the sub-packet. Service data units are sets of data sent by one peer service to another peer service of a given layer.

The combination of SDUs 214-216 and padding 218 can form MAC-HS payload 220. MAC-HS header 222 can be combined with payload 220 to form a sub-packet, such as sub-packets 206-210.

MAC-HS header 222 can include data that describes the location and size of each SDU 214-216. For example, VF is a data field for a version flag. Queue ID is a data field that provides identification of the reordering queue in the receiver. TSN is a data field for the transmission sequence number on the HS-DSCH. SIDₙ is a data field that identifies the size of a set of consecutive SDUs. Nₙ is a data field for the number of consecutive SDUs. Fₙ is a data field that indicates whether more SID fields are present.

Referring now to FIG. 3, there is depicted a representative diagram of a control channel transmission format in accordance with one or more embodiments. As shown, timeline 300 represents a plurality of transmission times 302 for transmitting control channel messages 304 on a high-speed shared control channel (which may be designated HS-SCCH) in accordance with one or more embodiments. Transmission times 302 start before transmission time intervals 202 (see FIG. 2) so that messages 304 can give advance notice to user devices 104-108 that a multiplexed packet having a designated sub-packet has been scheduled for transmission to the user device.

Control channel message 304 can include group ID 306 and intra-group data 308. In brief, group ID 306 is data that indicates that an upcoming multiplexed frame includes sub-packets for two or more members of the indicated group, and intra-group data 308 indicates the particular user devices in the group having designated sub-packets. It should be appreciated that, in the embodiment shown, the intra-group data includes portions that are only relevant to a particular user device within the group, where the user device and the relevant intra-group data are correlated or linked by the intra-group ID. In one embodiment, intra-group data 308 can be a bitmapped field wherein each bit is associated with an individual user device in the group designated by group ID 306, wherein the intra-group ID can act as an index or pointer to the relevant bit or other intra-group data.

Control channel message 304 can also include data indicating the modulation and coding scheme used for the multiplexed packet so that the user device can decode the packet correctly.

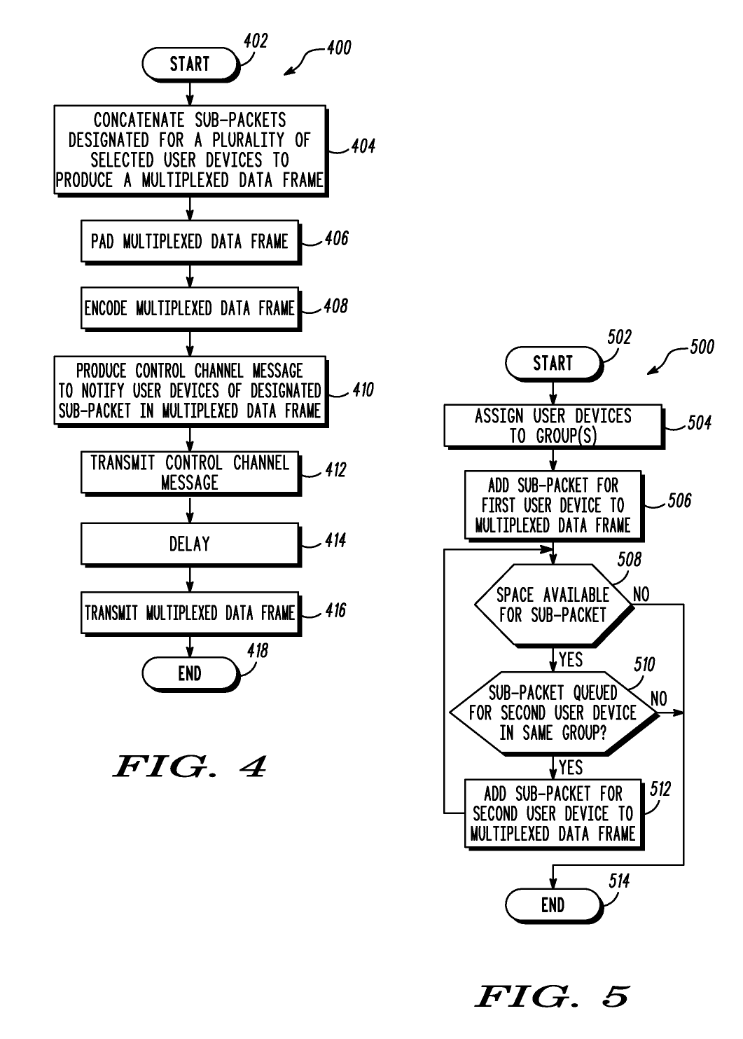

Referring now to FIG. 4, there is depicted a high-level flowchart of processes executed by a packet transmission system that can be used in conjunction with the FIG. 1 base station (e.g., base station 102), or another similar base station, in accordance with one or more embodiments. Process 400 begins at 402, and thereafter passes to 404, wherein the process concatenates sub-packets designated for a plurality of selected user devices to produce a multiplexed data frame. This step can be implemented as shown in FIG. 2 wherein sub-packets 206-210 are selected and grouped to produce multiplexed data frame 204. Note that multiplexed data frame 204 includes sub-packets that are designated for, or intended for transmission to, two or more user devices, such as sub-packet 206 designated for user 1 and sub-packet 208 designated for user 2.

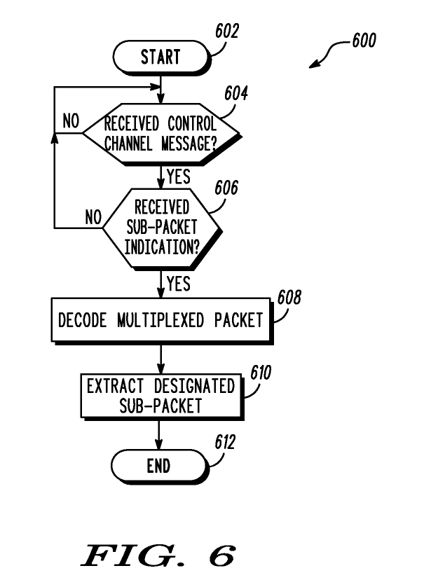

A more detailed flowchart of the process of concatenating sub-packets at 404 is shown in FIG. 5, where process 500 begins at 502, and thereafter passes to 504, wherein the process assigns user devices to one or more groups of user devices. Each group of user devices has a group ID, which can be, for example, an indexed value assigned as user devices become active in data communication system 100, or as user devices are initialized for a particular service provided by base station 102. In one embodiment, user devices can be assigned to a particular group based on similar channel conditions (e.g., similar average signal strengths, or a similar channel quality indicator (CQI), or the like), and each user device is assigned to a single group. When user devices having similar channel conditions are assigned to the same group, a coding scheme that is suited for the group (under present average conditions) can be selected. For example, an appropriate turbo coding rate can be selected based upon the “worst case” user device, or based on an average CQI of the user devices. In another embodiment, user devices can be assigned to more than one group, which can allow more flexibility in the grouping of user devices, and may also allow multiple-sized packets in a service for one user.

After assigning user devices to groups, the process adds a sub-packet designated for a first user device (e.g., user device 104) to a multiplexed data frame (e.g., multiplexed data frame 204), as depicted at 506. At this point, multiplexed data frame 204 includes one sub-packet.

Next, the process determines whether space is available in multiplexed data frame 204 for another sub-packet, as illustrated at 508. If space is not available, the process of concatenating sub-packets to form a multiplexed data frame ends, as illustrated at 514, wherein the process of FIG. 5 returns to 406 in FIG. 4.

If space is available, the process determines whether a sub-packet is queued for transmission to a second user device that is a member of the same group as the first device, as depicted at 510. If no sub-packets are queued for a user device in the same group, the process ends at 514. If there is a sub-packet for a user device in the same group, the process adds, or concatenates, the sub-packet for the second user device to the multiplexed data frame, as illustrated at 512. At this point, multiplexed data frame 204 includes two sub-packets for two different user devices.

After adding the second sub-packet, the process can iteratively return to 508 to determine if space is available for an additional sub-packet. This process can continue to add sub-packets to the multiplexed data frame as long as there is space available in the multiplexed data frame for packets designated for transmission to a user device in the same user group. Additionally, more than one sub packet of the same user device can be added to the multiplexed data frame.

Continuing now at 406 in the process shown in FIG. 4, the process can now optionally pad the multiplexed data frame. This padding can be implemented by adding zeros to the multiplexed data frame.

Once multiplexed data frame 204 as been produced, the process can encode the multiplexed data frame, as illustrated at 408. In one embodiment, turbo coding processes can be used to encode multiplexed data frame 204. Alternatively, other encoding processes can be used.

After encoding, the process produces a control channel message to notify two or more user devices of the designated sub-packets in the multiplexed data frame, as depicted at 410. In one embodiment, the control channel message can be implemented with, for example, control channel message 304, which includes group ID 306 and intra-group data 308 (such as intra-group bitmap 308). The reception of group ID 306 alerts user devices (e.g., 104-108) belonging to that particular group that they may have an upcoming sub-packet (e.g., sub-packet 206) transmitted in a multiplexed data frame (e.g., multiplexed data frame 204), and triggers the user devices to examine intra-group data 308 to determine whether it is one of the user devices that has a designated sub-packet included in the multiplexed data frame.

In one embodiment, intra-group data 308 can be implemented with a bit mapped field (also shown at 308) having a bit for each user device in the group, wherein the group can have from 1 to a maximum number of N user devices. For example, when user device 104 has a designated sub-packet 206 in multiplexed data frame 204, a corresponding bit, indexed in bit mapped field 308 from 1 to N according to the intra-group ID, can be set equal to “1”; otherwise, if no sub-packet for user device 104 is included, bit 310 can be set to “0.” For example, bit 310, which can correspond to user device 104 having an intra-group ID equal to “1,” can be set to 1 if user device 104 has a sub-packet designated for it in a forthcoming multiplexed data frame 204.

After producing the control channel message, the control channel message is transmitted on the control channel, as illustrated at 412. In one embodiment, the control channel is similar to a high-speed shared control channel known as HS-HCCH in the 3GPP standard. This control channel message gives notice to two or more selected user devices that an upcoming multiplexed data frame will contain one or more sub-packets designated for selected user devices, which are members of the same group.

After transmitting the control channel message to give notice to the user devices, the process delays, as illustrated at 414. The delay is a short period of time before the multiplexed data frame is transmitted. This delay allows time for the user devices to process the control channel message, and prepare to receive, demodulate, and decode the multiplexed data frame. The user device may also need to initialize or to wake up circuitry needed to received the multiplexed data frame.

Next, the process transmits the multiplexed data frame on the data channel, as illustrated at 416. In response to the control channel message that notifies two or more user devices that their sub-packets are in the multiplexed data frame, the notified user devices receive the multiplexed data frame, and then demodulate and decode the multiplexed data frame, and extract their respective sub-packets.

After transmitting the multiplexed packet, the process of communicating data executed in base station 102 ends, as illustrated at 418. Note that the process depicted in FIGS. 4 and 5 can be iteratively repeated for each multiplexed data frame sent for transmission.

Turning now to FIG. 6, there is depicted a high-level flowchart of processes executed by a multiplexed data frame receiver system—such as user device 104, or another similar device—used in conjunction with the FIG. 1 communication system in accordance with one or more embodiments. As illustrated, process 600 begins at 602, and thereafter passes to 604, were in the process determines whether a control channel message has been received. If a control channel message has not been received, the process interactively loops until such a control channel message is received.

After receiving a control channel message at 604, the process determines whether the user device has received an indication that a sub-packet will be transmitted to it in a forthcoming multiplexed data frame, as illustrated at 606. This process can be implemented by determining whether the group ID of the user device matches the group ID of the control channel message, and whether intra-group data in the control channel message indicates that the receiving user device, which has an assigned intra-group ID corresponding to a portion of the intra-group data, is one of the user devices in the group that has a sub-packet in a forthcoming multiplexed data frame. The intra-group data can be implemented with a bit mapped field (e.g. intra-group bitmapped data 308) where bits corresponding to intra-group IDs of the user devices are set, or not, depending upon whether a designated sub-packet is included in the forthcoming multiplexed data frame. In other embodiments, intra-group data can be a list of intra-group IDs, or intra-group data can include more than one bit of information corresponding to an assigned intra-group ID (e.g., three bits of data can be associated with an intra-group ID. Other embodiments can include additional intra-group data that characterizes the sub-packet designated for the user device. For example, intra-group data can indicate that the sub-packet has been encoded using a particular encoding technique. Intra-group data can also indicate whether transmission of the multiplexed data frame is a new transmission or a retransmission so that the user device can ignore retransmissions if it's sub-packet was properly received in a new transmission, thus saving power and processor bandwidth.

If the process in the user device has determined that a sub-packet designated for it will be included in an upcoming multiplexed data frame, the process receives, demodulates, and decodes the multiplexed data frame, as depicted at 608. The process then extracts the designated sub-packet, as shown at 610. The extraction process can be implemented by decoding the entire multiplexed data frame and using medium access control layer (i.e., MAC layer) data to determine which sub-packet belongs to the user device. The ciphering of the payload in the sub-packets can be used to prevent a first user device from gaining access to data designated for a second user device.

It should be apparent to those skilled in the art that the method and system described herein provides a number of improvements over the prior art. First, user devices 104-108 do not need to receive, demodulate, and decode every multiplexed data frame 204 in order to determine whether sub-packets designated for the user device are included in the frame. Instead, user devices are notified by a message on the control channel as to which multiplexed data frames 204 need to be received on the data channel to obtain the data designated for the user device. Second, the notification of which multiplexed data frames to receive is transmitted on the control channel, out of band, wherein messages on the control channel are in a format and data rate that takes less time to receive, and less power to receive, demodulate, and decode, thereby saving battery power in the user device. Third, the multiplexed data frames with the concatenated sub-packets can be jointly coded, thereby achieving a greater coding gain.

The above described functions and structures can be implemented in one or more integrated circuits. For example, many or all of the functions can be implemented in the signal and data processing circuitry that is suggested by the block diagrams, flowcharts, and data format diagrams shown in FIGS. 1-6.

The processes, apparatus, and systems, discussed above, and the inventive principles thereof are intended to produce a more effective communication system for transferring data packets from a base station to two or more user devices. By concatenating sub-packets designated for two or more user devices in a multiplexed data frame, and sending a control channel message to alert selected user devices of the designated sub-packets, data may be more efficiently transferred in data frames, and user devices can save energy and processing bandwidth by focusing on selected data frames containing sub-packets designated for the user device.

This disclosure is intended to explain how to fashion and use various embodiments in accordance with the invention, rather than to limit the true, intended, and fair scope and spirit thereof. The foregoing description is not intended to be exhaustive or to limit the invention to the precise form disclosed. Modifications or variations are possible in light of the above teachings. The embodiment(s) were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of communicating data comprising:
concatenating sub-packets designated, respectively, for a first user device and a second user device to form a multiplexed data frame;
producing a control channel message that indicates that the first and second user devices have sub-packets in the multiplexed data frame;
sending the control channel message for transmission on a shared control channel; and
sending the multiplexed data frame for transmission on a data channel.

2. The method of communicating data according to claim 1 comprising encoding the multiplexed data frame to produce an encoded data frame, and wherein the sending the multiplexed data frame for transmission on a data channel comprises sending the encoded data frame for transmission on the data channel.

3. The method of communicating data according to claim 1 wherein a plurality of user devices are each assigned to at least one of a plurality of groups, and wherein the first and second user devices are assigned to a first group of the plurality of groups, and wherein the concatenating sub-packets designated for the first and second user devices comprises concatenating sub-packets designated for at least the first and second user devices to form the multiplexed data frame, wherein all sub-packets in the multiplexed data frame are designated for user devices assigned to the first group.

4. The method of communicating data according to claim 3 wherein the first group has a first group identifier, and wherein all user devices assigned to the first group have an intra-group identifier, and wherein the producing a control channel message comprises producing a control channel message having the first group identifier, and intra-group data associated with respective intra-group identifiers assigned to the first and second user devices, wherein the intra-group data indicates whether a sub-packet is in the multiplexed packet that is designated for the first and second user devices, respectively.

5. The method of communicating data according to claim 4 wherein the intra-group data comprises a bit associated with each intra-group identifier in the first group, and wherein the producing a control channel message comprises setting a bit associated with each intra-group identifier of each user device in the first group having a sub-packet in the multiplexed packet.

6. A method of communicating data comprising:
receiving, in a first user device, a control channel message from a shared control channel;
in response to the control channel message, determining that a multiplexed data frame is scheduled for transmission on a data channel, and that the multiplexed data frame contains a sub-packet designated for the first user device;
receiving, in the first user device, the multiplexed data frame from the data channel; and
extracting the sub-packet designated for the first user device from the multiplexed data frame.

7. The method of communicating data according to claim 6 comprising decoding the multiplexed data frame.

8. The method of communicating data according to claim 6 wherein the first user device is assigned to a first group of one or more groups of user devices in the communication system, and wherein the first user device is assigned a first intra-group ID, and wherein the receiving a control channel message comprises receiving a control channel message having a first group identifier and first intra-group data associated with the first intra-group ID, wherein the first intra-group data indicates whether a sub-packet for the first user device is present in the multiplexed data frame.

9. The method of communicating data according to claim 8 wherein the first intra-group data comprises a plurality of bits in a bit mapped field, and wherein a first bit in the bit mapped field corresponds to the first intra-group ID, and wherein the first bit indicates whether a sub-packet for the first user device is present in the multiplexed data frame.

10. A base station in a communication system comprising:
data memory for storing data and software code;
a transceiver;
a processor coupled to the data memory and the transceiver, wherein the processor and the data memory are cooperatively operable to facilitate:
producing a multiplexed data frame for transmission on a data channel in the communication system, wherein the multiplexed data frame has sub-packets designated for a first user device and a second user device in the communication system;
producing a control channel message that indicates that the first and second user devices have sub-packets in the multiplexed data frame.

11. The base station according to claim 10 wherein the processor and the data memory are cooperatively operable to facilitate:
encoding the multiplexed data frame.

12. The base station according to claim 10 wherein the first and second user devices are assigned to a first group of one or more groups of user devices in the communication system, and wherein the first group has a first group ID, and wherein the first user device has a first intra-group ID and the second user device has a second intra-group ID, and wherein the processor and the data memory are cooperatively operable to facilitate:
producing a control channel message having the first group ID, and first and second intra-group data corresponding, respectively, to the first and second intra-group IDs that indicate that the first and second user devices each have sub-packets in the multiplexed data frame.

13. The base station according to claim 12 wherein the first and second intra-group data include corresponding bits in a bit mapped intra-group data field, wherein a first bit corresponding to the first intra-group ID is set when the first user device has a sub-packet designated for the first user device in the multiplexed data frame, and wherein a second bit is set when the second user device has a sub-packet designated for the second user in the multiplexed data frame.

14. A user device in a communication system comprising:
a transceiver;
data memory for storing data and software code;
a processor coupled to the data memory and the transceiver, wherein the processor and the data memory are cooperatively operable to facilitate:
receiving a control channel message from a control channel in the communication system, wherein the control channel message indicates that the user device and a second user device have sub-packets in a multiplexed data frame scheduled for transmission on a data channel in the communication system;
receiving the multiplexed data frame from the traffic channel; and
extracting the sub-packet for the user device from the multiplexed data frame.

15. The user device according to claim 14 wherein the processor and the data memory are cooperatively operable to facilitate:
decoding the multiplexed data frame.

16. The user device according to claim 14 wherein the user device is assigned to a first group of one or more groups of user devices in the communication system, and wherein the user device is assigned a first intra-group ID, and wherein the receiving a control channel message comprises receiving a control channel message having a first group ID and first intra-group data associated with the first intra-group ID, wherein the first intra-group data indicates whether a sub-packet for the user device is present in the multiplexed data frame.

17. The user device according to claim 16 wherein the first intra-group data comprises a plurality of bits in a bit mapped field, and wherein a first bit in the bit mapped field corresponds to the first intra-group ID, and wherein the first bit indicates whether a sub-packet for the user device is present in the multiplexed data frame.
